(19) United States
(12) Patent Application Publication
(10) Pub. No.: US 2004/0195715 A1
(43) Pub. Date: Oct. 7, 2004

(54) Method for setting and/or monitoring a press tool, and associated press control device

(76) Inventors: Herbert Ludwig Grobl, Murnau (DE); Walter Rau, Grossweil (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/830,756

(22) Filed: Apr. 23, 2004

Related U.S. Application Data
(63) Continuation of application No. PCT/DE02/03983, filed on Oct. 22, 2003.

(30) Foreign Application Priority Data
Oct. 24, 2001 (DE) 101 51 858.7

(51) Int. Cl. B29C 43/58

(52) U.S. Cl. 264/40.5; 425/149

(57) ABSTRACT

A controlling method for parallel controlling of a plurality of controllable tool devices is based on a procedure plan for a press lifting with respect to a press cycle, according to which pre-determined values for tool device parameters are determined and according to which a test lifting for examination of the controlling method will be started. For rationalisation of the method and in order to minimise technical faults as well as press standstill times, the test lifting is simulated as a virtual lifting in a computer device. In addition, to facilitate a long-term monitoring and analysis of changes with respect to the press and/or the tool during the pressing operation, at least one operation parameter may be registered, in order to be compared with earlier registered operation parameters.

### CROSS REFERENCE TO RELATED APPLICATIONS

This application is a continuation of PCT/DE02/03983 filed on Oct. 22, 2002.

### FIELD OF THE INVENTION

This invention relates to a method for setting and/or monitoring a press tool, and associated press control device.

### BACKGROUND OF THE INVENTION

For manufacturing of ceramic goods and compacts made from ceramic or metalliferous powders and granules there are used presses comprising tools, which are adapted to the compacts, whereby compressing pressures up to 800 t and more are brought into action. Because of the high pressures compressing of the individual press and tool components takes place during the pressing process being it therefore hardly possible to achieve a previous final precise adjustment or setting of the necessary compressing pressures and height adjustments of the individual press punches of the tool. The previous adjustment is particularly made more difficult with respect to especially tools, which are used for compacts, which have a fine structure, because of the number of press punches and tool axes, which are movable one against the other in a different way being in number maybe 10 and more.

For preparation of a machine controlling program for the press and the tool in a first working step there is made a number of graphic drawings, which correspond to the number of axes in order to make clear the necessary sequence of movements of the individual punches with respect to the basis of the press or the tool. With the help of these diagrams and drawings, respectively, in a succeeding step, a programming similar to a CNC-programming as generally known with respect to tool-machine-programming is carried out. After programming there is carried out a test lifting in order to establish, whether programming occurred in a correct way. Particularly, because of the aforementioned compressing problem but also because of the complex courses of movement of the individual axes and punches, respectively, one with respect to the other, according to this first lifting often errors or inexactnesses in the programming and/or the settings are turned out. Accordingly, later corrections in particular with respect to programming and further test liftings are necessary. Disadvantageously, this proceeding makes necessary a plurality of emergency stops as far as the first test liftings are concerned. Mainly in particular, during test liftings with inserted punches and with powder filled into the die opening of such a tool tool breaking can occur, when emergency stop does not occur in time.

With respect to such presses and tools a further problem is that the whole machine changes in the course of time. Changes can occur within a short time by alteration of setting of the individual punches one to the other or by alteration of ingredients or alteration of constitution of the powder and/or granules in use. Long-term changes may occur because of the high pressure forces, which exert on the individual tool components, particularly by compressing the punches and further tool components during each press lifting. For longer periods this leads to the problem that the individual punches and tool components cannot totally spring back into the original loadfree dimensions. In the end such alterations of the tool and its components lead to the fact, that the original programming does not produce correct pressing results any more. Therefore, short-time corrections have to take place within short periods, particularly within one tool cycle during setting, i.e. adjustment of the individual punches or during the programming. As tools for certain, often required compacts have to be inserted into the press, again and again, over long periods of time and have to be reused again, long-term changes have to be kept under surveillance for several months and years. Disadvantageously, after each insertion of a tool into the press after a longer standstill period changes have to be corrected with respect to the tool and its components as well as, possibly, with respect to the components of the press itself. This again makes necessary test liftings, too, which are connected with a standstill period of the whole plant on the one hand and the risk of tool break on the other.

From Hinzpeter Jürgen et al. (DE 197 17 217 C2) there is known a method and a device for manufacturing of compacts from hard metal, ceramics, sinter metal and the like. Thereby, under consideration of the material, which has to be pressed, and the feeding, a press error is determined during one single process and being compensated by alteration of pressure with respect to one specific pressing punch. In order to make possible the latter, via pressing tests a pre-determined curve is established and stored as a force-way-diagram. The real curve of later pressing procedures is compared with this pre-determined curve. Therefore, a possible error is compensated by a balancing comparison with the pre-determined curve as far as production of an individual compact is concerned.

From Liebl Hans (DE 37 15 077 C2) there is known a method for manufacturing of compacts and/or structured parts from pulverized or granulised materials being this method comparable with the aforementioned with respect to fundamental steps. Besides, there can be taken from, that in the course of one lifting the removing force is measured, when the press tools are removed, and being the removing force compared with pre-determined values for comparison, and that dependent on the results of comparison, the further controlling of the press, i.e. for the individual subsequent pressing procedures, is carried out. Particularly, there is provided an interruption of the removing, when the measured removing force is larger than a pre-determined value for comparison, in order to make possible a cleaning or an exchange of the tool.

From Yamamoto, Masao et al. (DE 42 03 401 A1) there are known a powder mould pressing method and a powder mould pressing device, according to which there is intended to press each graduated section of a graduated mould part equally in order to prevent by that way the building of cracks in the structured part and in order to make unnecessary the adjustment of a filling depth and a pressure in the cylinder, which belongs to the apparatus. According to this press method, there is furthermore intended to avoid bending of the posts and of the hydraulic cylinder for the different punch plates. The process of this method is calculated with the aid of target or pre-determined values. In order to solve this object it is suggested to determine a speed ratio of movement speeds of an upper and a lower punch part, when the particular graduated sections of the compact are pressed together during the time between the beginning and the end of the pressing, and besides, there is intended to determine a compression ratio of pressed dimensions of the graduated sections of the structured part or compact and to control the relative movement speeds of the upper punch part, of the lower punch part and the mould or die in such a way, that the speed ratios are in accord with the compression ratios of the graduated sections of the structured part.

The aforementioned methods of proceeding, therefore, regard to the determination of controlling parameters for a press. The afore-described problematic nature, however, essentially is not eliminated.

From Nakagawa, Tatsuji et al. (JP 07290294 A) there is known a method for preparing of operating data of a press. According to this method, in a first step simulations are carried out by calculation and being shown on a screen, the simulations being calculating a pressing procedure, which is to be carried out at a later time. As soon as the simulation result corresponds to the demands, then, in a second method step conversion into controlling operating data of the appropriate press takes place. With the help of these controlling operating data the machine will be driven in the following being finally explicitly stated that the test processing, which by the expert is also called test lifting can be shortened by a plurality of test liftings with respect to the proceeding up to now. What remains problematically, however, is the danger of error caused by input error, not considered parameters with respect to the simulation program, conversion errors into the machine parameters and mistakes as far as input of machine parameters into the press is concerned.

Hinzmann et al. (U.S. Pat. No. 5,043,111) discloses a process for manufacturing die-formed parts by compressing powder material between the pressing faces of punches. The process serves for compensating the elastic deformation of the punches as a result of the action of the pressing force in the press limit position. According to one embodiment this is done by constantly monitoring the effect of the pressing forces on the punches to compensate for elastic deformations a uniformity in the configuration of the die-formed part for each successes a cycle. That is, if there is registered a deformation the deformation is compensated in the next pressing cycle. According to another embodiment the pressing force is measured on at least one of the punches during the pressing cycle, and is used to calculate the corrected specified position for the punches in the same pressing cycle.

### SUMMARY OF THE INVENTION

An object of the invention is to suggest a method for setting and/or monitoring of a press tool and/or a press tool and/or a press controlling device in order to make possible a more effective programming and/or monitoring of the programming and the tool.

This object is solved according to a first preferred embodiment by a method for setting of a ceramic or metal powder press tool, wherein a controlling method for parallel controlling of a plurality of controllable tool devices is provided, which is based on a procedure plan for a press lifting for a press cycle, target or pre-determined values being determined for tool device parameters and a test lifting being started for examining of said provided controlling method, wherein said test lifting is simulated in a computer device according to expected moving procedures with said provided controlling method.

The arithmetic-technical simulation method of a press lifting in a calculating device makes possible a first examining of the established procedure of the method and/or the programming, which correspondingly has been implemented. Furthermore, via the taking in of operating parameters a deviation of the real values in relation to the pre-determined values can be detected and can be corrected accordingly on the tool or in the programming. Therefore, the number of emergency stops or even tool breaks can be minimized significantly.

Advantageously, by simulation in a calculating device already before the insertion of a tool into the press an optimal programming can be provided being it thereby possible to minimize also the real standstill time in the press. This advantages are possible by especially a method, wherein within said test lifting simulated real values are determined, being compared with said pre-determined values, and according to which said test lifting is repeated with adapted controlling method until a deviation of said real values and said pre-determined values lie within a pre-given scope of tolerance.

The determination of real values in the virtual test lifting makes possible a comparison with pre-determined values, which have been determined in advance, being it therefore possible to carry out a manual or automatically adaptation of the controlling program. In a purposeful way, after such adaptation of the controlling program the virtual test lifting is being repeated being this procedure repeated until the real value and the pre-determined value lie within a pre-set range of tolerance. One of these advantages can be achieved by especially a method, wherein for one or more parameters in case of a deviation larger than a critical tolerance an output occurs to a user, and, in particular, a continuation of said controlling method being interrupted until a new release with adapted parameter/s occurs.

A particular advantage is an automatic adjustment or setting of parameters for the programming being it possible to fall back on known minimizing methods and e.g. iterative or interpolating methods. If in case of deviation, which is larger than a pre-determined critical tolerance, the output occurs to a programmer or another user, then this one can also perform an examination or a manual correction of the parameters, before a further automatic adjustment of the programming will be continued. This makes possible aside from the consideration of special tool-specific parameters also a manual correction for the case of changed powder or granule composition.

With regard to the real programming mechanisms in an advantageous way it is possible to fall back on the principles of a CNC programming being generally known. Especially, it is advantageously to provide a method, wherein said controlling method is carried out in form of a CNC-programming as a controlling program.

In addition to the consideration of the parameters, which are pre-determined in advance with respect to the programming, it is an advantage to carry out a plausibility examination during the production of the controlling program and/or during the test lifting with reference to the individual parameters. On that occasion, particularly, ways, liftings and positions of the individual tool elements and the forces, which act on them, can be considered. Considerable, however, are also changeable parameters, e.g. different powder and/or granule compositions.

Further, the object of the invention is solved in an independent way by an embodiment comprising a method for monitoring of a ceramic or metal powder pressing process, of a ceramic or metal powder press and/or a ceramic or metal powder tool, according to which a controlling method controls a plurality of controllable tool devices of a pressing process or of a press tool by a plurality of press cycles, wherein said controlling of the individual tool devices occurs dependent on pressing process, tool and/or press material parameters, wherein during the pressing operation for its monitoring at least one operation and/or state parameter is registered and put out, said at least one registered operation and/or state parameter being compared with one or more operation and/or state parameter/s determined or registered at at least one earlier point of time.

In an advantageous way, during the test liftings and also during the later operation a monitoring of the operation-parameters is carried out. For that purpose, operation parameters can be determined and registered at any moment or also temporally shifted points of time, in order to make possible comparison of such operation parameters with pre-determined values or real values and/or operation parameters, which have been registered at an earlier point of time.

In an advantageous way, in case of deviation larger than a pre-given tolerance an error program will be started. According to the error arousal the error program can make an automatic correction of the controlling program or the parameters used for it or can also cause a breaking-off of the whole running operations.

In case of more little deviations during the operation process, however, there is also only possible analysis and documentation of the ascertained deviations by means of the error program. Purposefully, registered parameters and deviations are directly made visible by the error program on a machine controlling device, on a central controlling device or somehow on a distant place. As a distant place, particularly, there also can be used a monitoring device of the press or tool manufacturer, to which the appropriate data can be communicated e.g. via telecommunication connections. By means of this, the manufacturer of the press or of the tool can monitor on a fairly long-term basis, in order to be able to make corresponding preparations for the cyclic maintenance work or, however, to be able to identify fundamental problems of the press or the tool in time.

The registration of the individual operation parameters can occur in different ways. Besides the direct pick up of the parameters by stretching and/or compressing measuring-strips on the individual components there also can be carried out e.g. laser-supported or other way-measuring methods, acceleration-measurements, speed-measurements with respect to the moving components, but also conductivity-measurements with respect to single components or finished compacts, besides the different ways of pressure registration. Pressures can be used in a purely mechanical way as well as by means of corresponding press sensors in the hydraulic field with respect to hydraulic presses.

Such a reference procedure for monitoring of especially the tool makes possible, therefore, recording, documentation, and analysing of achieved parameters and results. Comparison of values can be carried out automatically and/or manually by means of lists and diagrams. Beside the analysis of deviations, there, particularly, drawing up of recommendations for future proceeding/construction and the construction of a database comprising data, which show success and failure of the different discoveries, are possible. The manual start of the monitoring serves for establishing of changes on the tool or the press after e.g. longer breaks or removing time of the tool.

For testing of the press as such there can also be provided a testing tool beside a routinely used tool.

Purposefully, there is established a data bank, which comprises controlling and monitoring methods according to each single tool type or each single tool. As a result of it, there, from the manufacturer side, are particularly also possible speeded up adaptations to change of tools by means of recourse to programs of comparable existing tools. Particularly, from the user side, there can be concluded interim changes from recourse to existing data with respect to past longer time cycle of use of a tool.

Therefore, in an advantageous way, there can be provided a monitoring or testing cycle, after the course of which special analysing methods, being automatically or manually started, begin to run.

Especially, it is advantageously to provide a method, wherein in case of a deviation larger than a pre-given scope of tolerance an error process will be started. Especially, it is advantageously to provide a method, wherein said error process puts into effect an automatic correction of said controlling method or recommends it to an user. Especially, it is advantageously to provide a method, wherein operation and/or state parameters are being analysed and evaluated and/or documented. Especially, it is advantageously to provide a method, wherein a controlling method and/or operation parameters of such a method are used as controlling or reference method. Especially, it is advantageously to provide a method, wherein said registered operation parameters will be communicated to a press-external controlling device in order to monitor and/or to correct pressing. Especially, it is advantageously to provide a method, wherein during said providing of the controlling method and/or a test lifting a plausibility examination will be carried out or considered, particularly a plausibility examination with respect to ways, liftings, positions of individual tool elements and/or forces acting on them. Especially, it is advantageously to provide a method, wherein influences by alteration of said material, which has to be pressed, are considered by adaptation of parameters and/or adaptation of the procedural steps. Especially, advantageously is a method, wherein for determination of changes of parameters of said tool or said press itself a registered parameter will be compared with a parameter, which has been registered at an earlier point of time, to be a reference value.

Further, the object of the invention is solved advantageously by a press control device comprising a controlling device for a press tool with a plurality of controllable tool devices and value of measurement receptor devices for registering of press and/or tool parameters, said controlling device being established for controlling of said tool devices and for monitoring of said registered press and/or tool parameters and said controlling device being established for the performance of such a method.

### BRIEF DESCRIPTION OF THE DRAWINGS

An embodiment is explained on the basis of the drawing in the following in more detail. There is shown in:

FIG. 1 a cut of a press tool with schematically represented controlling elements,

FIG. 2 a diagram of the course of the programming and the execution of a virtual lifting and

FIG. 3 a diagram of the course for monitoring of the operation of the corresponding press.

### DETAILED DESCRIPTION OF AN INVENTIVE EMBODIMENT

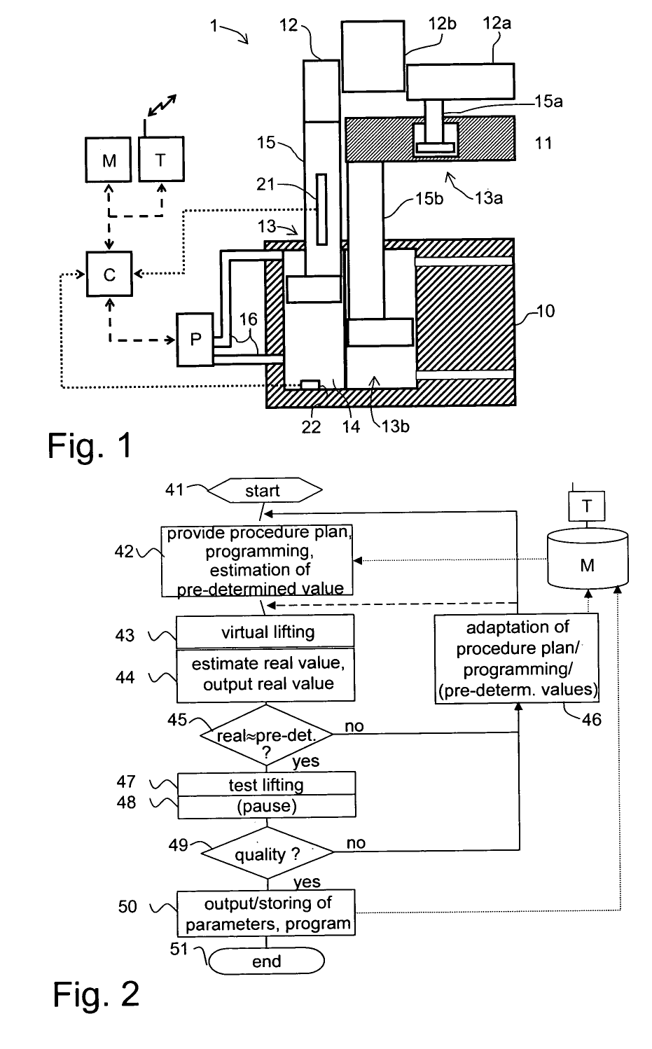

As can be seen from FIG. 1, a press or a tool 1 inserted therein have a plurality of movable components. Among them, there are, in particular, a base plate 10, which, in the majority of cases, is mounted within the tool frame of the press in a non-movable way. The base plate 10 serves for supporting a plurality of individual plates and punch carriers 11 movably relative to this base plate 10. Furthermore, individual punches 12 can be directly supported on the base plate 10 and on the further individual plates or punch carriers 11, the punches 12 ending up as press punches for the pressing of powder or granules in a die opening, which can be fed with powder, serving, there, for pressing the powder in a structure-giving way. Relative to the base plate 10, piston and cylinder arrangements 13 serve for the moving of the individual punches 12 and/or plates and punch carriers 11, comprising a cylinder chamber 14 and a piston rod 15, the piston rod immersing therein with a corresponding piston ring. For operation of the piston/cylinder arrangements 13 the two sub-chambers of the cylinder chambers 14 are supplied with a corresponding hydraulic medium via hydraulic pipes 16 by means of a hydraulic pump P.

Beside the insertion of a piston/cylinder arrangement 13 into the base plate 10, such piston/cylinder arrangements 13a can also be directly arranged e.g. within the further plates or punch carriers 11, as can be seen from punch 12a being supported on a corresponding piston rod 15a. The movement of the punch 12a relative to the base plate 10, therefore, occurs via a piston rod 15b, which is movably mounted in a corresponding piston/cylinder arrangement 13b within the base plate 10, and in addition, this movement occurs via the piston/cylinder arrangement 13a, which is arranged in the punch carrier 11. It is, therefore, a matter of two adjustment, i.e. setting possibilities coupled together for the punch 12a in relation to the base plate 10.

At least one central controlling device C serves for controlling the various necessary hydraulic pumps P being, advantageously, coupled with a memory M to store operation parameters and parameters for individual tools. The hydraulic pumps P as well as the central controlling device C and the memory device M can be, all of them or in part, part of the tool, but they can also be part of the press or part of a separate service device being coupled with the press.

In order to make possible a monitoring of the individual movements, forces and the like, there, furthermore, are provided various receptors on the press and/or the tool 1 and its components for measuring of the values. Such value of measurement receptors can be e.g. measuring strips 21, which e.g. on a piston rod 15 serve for registration of its compression during the press lifting. Possible is also the use of pressure receptors 22, which register the hydraulic pressure that prevails in the area of the cylinder chamber 14. Possible is also e.g. the use of pressure receptors in the transitional areas between e.g. a piston rod and a plate, which is fastened thereon. Further value of measurement receptors can determine e.g. the conductivities of individual compressed components or of the finished compacts or they can also use ultrasound or laser rays for height measurement and the like. It can also be measured the temporal sequence, e.g. for registering the required pressing time from the beginning of the pressing until the end of the compressing process.

According to the complexity of the tool, some few up to several dozens and more individual components of a tool are controllable relative to each other. The number of measured values, which can be registered, can also amount from zero up to several dozens and more parameters, according to the development of the tool. Within the bounds of a controlling method or controlling program, advantageously, all parameters according to the individual tool components and all parameters, which can be taken in by means of value of measurement receptors, are considered.

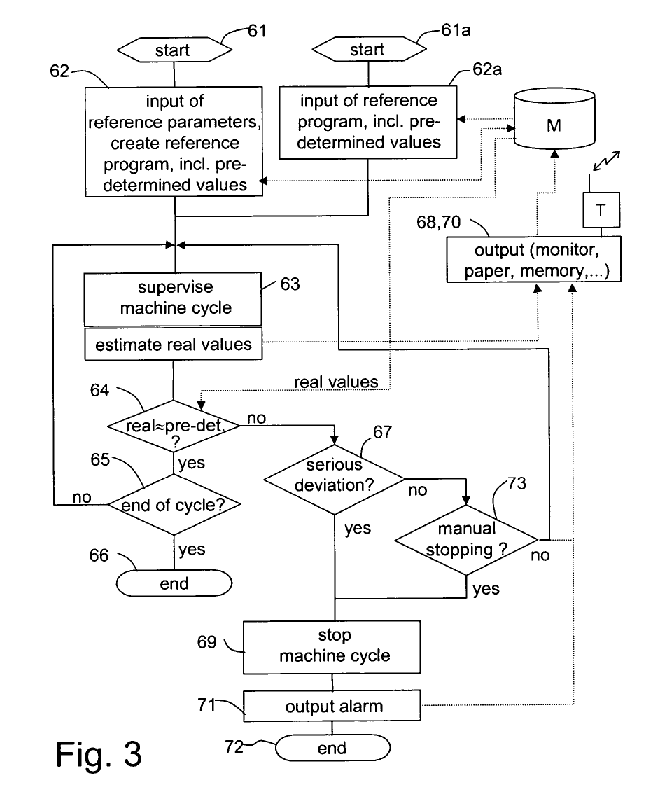

In the following, there is described such a controlling method and controlling program, respectively, being subdivided into two modules, both of which, advantageously, also can be brought into action as independent controlling programs. On that occasion, FIG. 2 presents a controlling program or a controlling module, via which a first adjustment and production of the real controlling program for the press lifting is described. FIG. 3 describes a reference program or an extended controlling program being designed for the monitoring of the functions and, optimally, for taking appropriate measures in the case of deviations and errors. Continuous lines indicate sequences of proceeding, dotted lines indicate controlling data or data, which have to be stored.

As can be seen from FIG. 2, with the start 41 of the method the program or the process for setting of a press tool begins, wherein as a press tool it is not only to be understood such one for hydraulic or mechanical powder presses but also one for different presses, in particular concerning the powder metallurgical and the ceramic area.

In a first actual step 42 a plan of the procedure is created. The plan of the procedure thereby is transferred into a corresponding controlling method, being, on that occasion, in an advantageous way, pre-determined values for the individual components and measurable operation parameters determined and considered. When the plan of the procedure is created, there is used a plurality of parameters, which are stored in a memory device M. It is also possible to produce and to deposit a complete procedural plan or a correspondingly programmed controlling method or controlling program within a memory device e.g. the memory device M, separately.

In an advantageous way, for illustration and examination for the operator of the tool there is provided an output on a screen and/or a graphic print-out of the individual procedural steps and parameters.

In an ideal way, the procedural method considers already procedural steps with plausibility examinations, which avoid the exceeding of permissible limits or pressures, as e.g. they can occur in situations, where the piston/cylinder arrangement 13a moves the punch 12a, being the piston/cylinder arrangement 13a again arranged in the plate 11, which is movable by the further piston/cylinder arrangement 13b.

After termination of the corresponding procedural method a test lifting 43 is carried out being, in the following, also called virtual lifting 43. According to this virtual lifting 43 the individual movements are simulated, the results being put out as real values. Advantageously, the individual forces of the different components, which are acting, can also be considered in an area-technological way. Thereby, the output can occur in numerals and/or graphically in order to be visually examined. In a further procedural step there occurs an interrogation 45, in the course of which the pre-determined values, which have been determined within the bounds of procedural plan production 42, are compared with the real values 44, which have been determined from the virtual lifting 43.

If single, certain or all real values lie outside the scope of permissible tolerances of the pre-determined assigned values, then a new determination or adjustment of the corresponding parameters or of the controlling method in a further setting step 46 will be carried out. The adjustment can be carried out automatically, particularly in an iterative way, but it also can be done manually by means of manual input of new parameters or manual alteration of the procedural steps. It is also possible a combination of automatic and manual adaptation e.g. if for single parameters it was pre-determined that automatic adaptation is permissible or not. According to the procedural plan production step 42 again ideal pre-determined values are determined, if an adaptation of the pre-determined values was found to be necessary. Advantageously, the determined parameters and procedural steps also in the adaptation step 46, as in the procedural plan production 42, too, are deposited in the memory device M.

After the adjustment in the adaptation step 46 the method is continued before and/or behind the step of procedural plan production 42, according to the requirements, being repeated until with respect to the interrogation 45 when comparing the pre-determined values with the real values it is determined that all values lie within the permissible scope. For that case a first test lifting 47 will be carried out, which, in an advantageous way, can be monitored optically.

After the test lifting 47 a break 48 will be performed in the procedural method, in order to make possible examination of the compact and of the tool. If all conditions are fulfilled, in a further interrogation step 49 the output of the individual parameters, values and procedural steps into the memory device M and/or the controlling device C will be provided for the controlling of the further procedural process in the output step 50, which will be followed by the end 51 of the procedural process in order to adjust the press tool.

In that case that during or after the test lifting 47 deficiencies are detected with respect to the compact and/or the tool, a backward step occurs from the interrogation step 49 to the adaptation step 46 or to a comparable adaptation step, in order to adapt individual parameters and/or the procedural course to the individual components of the press tool, accordingly.

All procedural steps involved, which have been described in the aforementioned setting of the press tool, can be considered with respect to plausibility examinations and/or with respect to the measured values, which can be gathered via the aforementioned or other measuring receptors. While during the first part of the procedural course a virtual calculation of the procedure takes place, which comprises a virtual real value determination, in the second part of the procedure there occurs a test lifting 47, according to which the real measured values can be the basis of a pre-determined value—real value comparison. There has to be noticed, that the step of the test lifting optimally also can be avoided, when in the first part of the procedural course the procedural course is ideally pre-adjusted. In the further course of the procedure, i.e. in the course of the real producing of the compacts, there is executed monitoring of the press parameters, of the tool parameters and, optionally, of the quality of the compacts by means of the procedural course, which is illustrated in FIG. 3. Thereby, this monitoring can be used for short-term alterations as well as for long-term alterations of the different parameters. On that occasion, the in the following described procedural course can be carried out as an independent procedure, particularly as an independent software program, but it can also be integrated into the controlling method for the controlling of the pressing, thus becoming part of the general controlling procedure. Subsequently, there is described an exemplary reference method or reference program, which is being brought into action as an independent program apart from the real controlling program.

Conforming to the desire, after the start 61 and 61a, respectively, the input of reference parameters 62 or the input of a reference program 62a can be executed into a corresponding controlling device C.

Reference parameters for an existing reference program as well as a tool-specific reference program can be put in manually, they, however, also can be taken from a memory device M. The memory device M, thereby, can be part of a tool, part of a press or can be a separate memory device M within a separated controlling device. Reference parameters as well as a reference program, advantageously, can be gathered from a method for adjustment of the press tool, as it can be seen from the procedure described in FIG. 2, for example. However, there is also possible a general new determining of the individual necessary parameters and procedural steps. The creation of a reference program and/or of reference parameters, particularly, can also occur with the use of measured values, which can be registered or gathered, when setting of the press tool takes place and/or during the later operation. In particular, it is useful to store the corresponding parameters and procedural steps in the memory device M, at any time, in order to be able to perform, at a later point of time, comparisons with then actual values or in order to be able to fall back on these values, at a later point of time, when the tool will be brought into service once again.

After providing of the reference method comprising the reference parameters the continuous machine cycle will be examined. The examination, thereby, can occur continuously in that way, that a continuous monitoring with respect to each individual press lifting will be executed. There is possible, however, a continuous monitoring after a pre-determined number of press liftings or after a pre-determined space of time between the single examinations steps 63. According to preferred embodiments, the examination will be caused manually, according to requirement. After examination 63 of a machine cycle, according to which real values are registered or indirectly determined, a comparison via an interrogation 64 will be executed, being, thereby, used previous pre-determined values. The previous pre-determined values can be e.g. set in advance as reference parameters or they can be registered and/or determined at previous points of time. After such a real value/pre-determined value comparison and if the values lie within a scope of tolerance, this examination 63 of the machine cycle is continued until the cycle end 65 before the reference method 66 ends.

If with respect to the interrogation 64 a too large deviation between real values and pre-determined values for the individual or all values is observed, purposefully, in a further interrogation 67 it will be examined, if it is the case of a serious deviation. If no, the examination 63 of the machine cycle is continued as generally known, on the occasion of which an output 68 on e.g. a screen or a printout for the service staff occurs. Particularly, deviations are also registered in the memory device M, in order to be available for later analysis and evaluation. If in the interrogation 67 a serious deviation is registered, there can be provided, that the machine cycle 69 stops immediately. Besides, there occurs an output 70 on a screen or another monitoring medium, being associated with an alarm 71, after which the reference method and the reference program, respectively, will be terminated 72. A new start, purposefully, will be executed with the new start of the machine cycle after remedy of the disturbance.

If the deviation is not serious, there can be provided, that, beside an output 68 for the service staff, a manual stop 73 is possible. In the case of a manual stop the procedure of the reference method also ends, being it possible to start again manually or automatically continuing the machine cycle.

Particularly, in the case of an alarm 71, but also in other cases, beside the output of parameters and messages, in addition, there can be made transmission of the corresponding data via a telecommunication device T to a distant monitoring device. Such a distant monitoring device can, beside the central office of the driver of the press or the press tool, also be the manufacturer of the press or the press tool. This serves, on the shortest way, for a continuous monitoring of the individual components by the manufacturer, which again can prepare and execute appropriate measures, when disturbance or alteration, particularly a continuous alteration, is detected. It goes without saying, that there also generally can be transmitted the values from the memory device M with the individual reference parameters and/or reference programs out of the memory device M or into it by means of a corresponding data long-distance line or via a telecommunication interface T.

The invention as described herein above in the context of the preferred embodiments is not to be taken as limited to all of the provided details thereof, since modifications and variations thereof may be made without departing from the spirit and scope of the invention.

1. Method for setting of a ceramic or metal powder press tool, wherein
a controlling method for parallel controlling of a plurality of controllable tool devices is provided, which is based on a procedure plan for a press lifting for a press cycle,
target or pre-determined values being determined for tool device parameters and
a test lifting being started for examining of said provided controlling method, wherein
said test lifting is simulated in a computer device according to expected moving procedures with said provided controlling method.

2. Method according to claim 1, wherein
within said test lifting simulated real values are determined, being compared with said pre-determined values, and according to which
said test lifting is repeated with adapted controlling method until a deviation of said real values and said pre-determined values lie within a pre-given scope of tolerance.

3. Method according to claim 2, wherein
for one or more parameters in case of a deviation larger than a critical tolerance an output occurs to a user, and, in particular, a continuation of said controlling method being interrupted until a new release with adapted parameter/s occurs.

4. Method according to claim 1, wherein said controlling method is carried out in form of a CNC programming as controlling program.

5. Method for monitoring of a ceramic or metal powder pressing process, of a ceramic or metal powder press and/or a ceramic or metal powder tool, according to which a controlling method controls a plurality of controllable tool devices of a pressing process or of a press tool by a plurality of press cycles, wherein said controlling of the individual tool devices occurs dependent on pressing process, tool and/or press material parameters, wherein
during the pressing operation for its monitoring at least one operation and/or state parameter is registered
said at least one registered operation and/or state parameter being compared with one or more operation and/or state parameter/s determined or registered at at least one earlier point of time.

6. Method according to claim 5, wherein in case of a deviation larger than a pre-given scope of tolerance an error process will be started.

7. Method according to claim 6, wherein said error process puts into effect an automatic correction of said controlling method or recommends it to an user.

8. Method according to claim 6, wherein operation and/or state parameters are being analysed and evaluated and/or documented.

9. Method according to claim 5, wherein a controlling method and/or operation parameters of said method according to claim 1 are used as controlling or reference method.

10. Method according to claim 5, wherein a controlling method and/or operation parameters of said method according to claim 2 are used as controlling or reference method.

11. Method according to claim 5, wherein said registered operation parameters will be communicated to a press-external controlling device in order to monitor and/or to correct pressing.

12. Method according to claim 1, wherein during said providing of the controlling method and/or a test lifting a plausibility examination will be carried out or considered, particularly a plausibility examination with respect to ways, liftings, positions of individual tool elements and/or forces acting on them.

13. Method according to claim 5, wherein during said providing of the controlling method and/or a test lifting a plausibility examination will be carried out or considered, particularly a plausibility examination with respect to ways, liftings, positions of individual tool elements and/or forces acting on them.

14. Method according to claim 1, wherein influences by alteration of said material, which has to be pressed, are considered by adaptation of parameters and/or adaptation of the procedural steps.

15. Method according to claim 1, wherein for determination of changes of parameters of said tool or said press itself a registered parameter will be compared with a parameter, which has been registered at an earlier point of time, to be a reference value.

16. Method according to claim 5, wherein for determination of changes of parameters of said tool or said press itself a registered parameter will be compared with a parameter, which has been registered at an earlier point of time, to be a reference value.

17. Method according to claim 9, wherein for determination of changes of parameters of said tool or said press itself a registered parameter will be compared with a parameter, which has been registered at an earlier point of time, to be a reference value.

18. Press control device comprising
a controlling device for a press tool with a plurality of controllable tool devices and value of measurement receptor devices for registering of press and/or tool parameters,
said controlling device being established for controlling of said tool devices and for monitoring of said registered press and/or tool parameters and said controlling device being established for the performance of a method according to claim 1.
